(19) United States
(12) Patent Application Publication
(10) Pub. No.: US 2021/0373914 A1
(43) Pub. Date: Dec. 2, 2021

(54) BATCH TO STREAM PROCESSING IN A FEATURE MANAGEMENT PLATFORM

(71) Applicant: INTUIT INC., Mountain View, CA (US)

(72) Inventors: Nicholas Jeffrey HOH, Sunnyvale, CA (US); Karthik PRAKASH, Milpitas, CA (US); Pankaj RASTOGI, Fremont, CA (US); Sumanth VENKATASUBBAIAH, Mountain View, CA (US)

(21) Appl. No.: 16/887,794

(22) Filed: May 29, 2020

(51) Int. Cl. G06F 9/445

(52) U.S. Cl. CPC G06F 9/44505

(57) ABSTRACT

Certain aspects of the present disclosure provide techniques for a “hand-off” operation of a feature management platform. A feature management platform can receive a request to generate feature data based on batch and streaming data. To generate such feature data, a “hand-off” occurs between a batch processing job to a stream processing job. The feature management platform can initiate the batch processing job to generate a first set of feature data. Once all of the feature data is generated by the batch processing job, the feature data is saved in an offline database. The feature data with the maximum timestamp is saved in an online database, and the maximum timestamp is saved in a persistent database. With the maximum timestamp, the feature management platform begins the stream processing job. Once feature data is generated by the stream processing job, the feature data is stored in an offline or online database.

### INTRODUCTION

Aspects of the present disclosure relate to the operation of a feature management platform configured to manage the full lifecycle of feature data.

### BACKGROUND

Within the field of data science and analytics, artificial intelligence and machine learning are rapidly growing. More and more entities and organizations are adopting and implementing such technologies. As the field (and popularity) of artificial intelligence and machine learning grows and further develops, so too does the technology for supporting artificial intelligence and machine learning. One such technology focuses on data processing. Generally, large amounts of feature data are needed to train artificial intelligence and machine learning models. Such data can be used both to train models and to generate predictions for specific use cases based on the trained models.

In order to implement data processing at the scale and level feasible for artificial intelligence and machine learning models, a significant amount of resources is often devoted to the collection, transformation, and storage of data. Not only that, the time and costs associated with developing data processing techniques for artificial intelligence and machine learning models can be high. There is also the risk of generating duplicate feature data when implementing data processing techniques, resulting in more resources being consumed then necessary. Further, there is also a dependence on data engineers when attempting to manage the full lifecycle of feature data. In such instances, the dependence on data engineers also increases the time with which it takes to provide useful feature data. Additionally, conventional methods of data processing are time-intensive and often lack the latest feature data, preventing timely generation of predictions by artificial intelligence and machine learning models, such as for fraud detection, user support, and so forth. As a result, organizations and entities implementing artificial intelligence and machine learning models may base decisions on low quality predictions (e.g., predictions based on old feature data).

Conventional methods attempt to address the shortcomings (as described above) of data processing of feature data. However, conventional methods are often standalone ad hoc solutions that lack the governance, model integration, and flexibility to create feature data for streaming (or real-time) and batch aggregations. Additional limitations of conventional methods include a lack of reusability and shareability of the feature data as well as the failure of the conventional methods to manage the entire lifecycle of feature data in a reliable, scalable, resilient, and easily useable manner.

As such, a solution is needed that can overcome the shortcomings of the conventional methods to manage the complete lifecycle of feature data in a scalable and reusable manner.

### BRIEF SUMMARY

Certain embodiments provide a method for a feature management platform that operates to manage feature data. The method includes receiving a configuration file for a feature from a computing device, wherein the configuration file defines a transform to apply to event data to generate the feature. The method further includes generating, based on the configuration file, a processing job that includes a hand-off between a batch processing job and a stream processing job. The method further includes initiating the batch processing job of the processing job that includes: retrieving a first set of event data for the batch processing job based on a start time parameter in the configuration file; applying the transform to the first set of event data for the batch processing job to generate a first set of feature data; determining there is no more event data in the first set of event data for the batch processing job; and storing a maximum timestamp of an event datum from the first set of event data. The method further includes initiating the stream processing job of the processing job that includes: retrieving the stored maximum timestamp of the event datum from the first set of event data; based on the maximum timestamp, retrieving a second set of event data for the stream processing job, wherein each event in the second set of event data includes a timestamp greater than the stored maximum timestamp of the event datum from the first set of event data; and applying the transform to each event data in the second set of event data until reaching an end time parameter to generate a second set of feature data.

Other embodiments provide systems for a feature management platform that operate to manage feature data and/or predictions. Additionally, other embodiments provide non-transitory computer-readable storage mediums comprising instructions for a feature management platform that operates to manage feature data and/or predictions.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example feature management platform, according to an embodiment.

FIG. 2 depicts an example diagram of the transition between a batch processing job and a stream processing job, according to an embodiment.

FIG. 3 depicts an example flow diagram of the feature management platform generating feature data, according to an embodiment.

FIG. 4 depicts an example pipeline of the feature management platform, according to an embodiment.

FIG. 5 depicts an example configuration file, according to an embodiment.

FIG. 6 depicts an example flow diagram of the feature management platform managing feature data, according to an embodiment.

FIG. 7 depicts an example flow diagram of the computing device interacting with the feature management platform, according to an embodiment.

FIG. 8 depicts an example server for the feature management platform, according to an embodiment.

FIG. 9 depicts an example computing device, according to an embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and non-transitory computer readable mediums for the operation of a feature management platform, which is an end-to-end platform for managing the full lifecycle of feature data (e.g., discovery, creation, use, governing, and deployment of feature data).

Organizations and entities that depend on feature data processing for artificial intelligence and/or machine learning (AI/ML) models can implement a feature management platform. Due to the pluggability and multi-tenancy nature of the feature management platform, multiple types of computing devices (or client devices) can connect to (or “plug” into) the feature management platform for discovering, creating, sharing, re-using, etc., feature data, including stateful and stateless features. Such data is used for training and implementing use cases of models on computing devices. Further, the feature management platform can interact with computing devices and/or models to receive and distribute generated predictions.

Generally, feature data can include event data that is featurized, such as geographic lookups (e.g., based on IP addresses, zip codes, and other types of geographic identifying data), counts of user activity (e.g., clicks on a link, visits to a web site, and other types of countable user activity), and other types of featurized data based on event data collected by an organization. The event data can include raw data gathered through interactions and operations of the organization. For example, an organization that provides user support of products and/or services offered by that organization can collect information (e.g., event data) such as IP addresses of users accessing online user support, number of times a user contacts user support (e.g., via phone, email, etc.), and so forth. Such event data can be featurized to generate feature data, which can include stateful features and stateless features, by the feature management platform. For example, stateful features can be calculated using aggregation operations over a period of time (e.g., count, count distinct, sum, min, max, etc.). Stateless features can be the last value (or latest in time value) of a feature (e.g., a last IP address of a user).

The feature data can be retrieved (e.g., via computing devices) from the feature management platform to train and implement models to generate predictions that can assist the organization in making operational decisions. Further, the feature management platform can interact with computing devices to receive and distribute predictions generated to other models and/or computing devices, which in turn can reduce the consumption of resources by an organization including computing resources, time, money, etc.

The feature management platform provides the tooling and framework for managing data transformations, which in turn allows for creation of feature data for AL/ML models. The feature management platform includes components that enable the sharing and reusability of feature data (e.g., stateful and stateless features) to other models as well as reducing data corruption and data duplication. Further, the feature management platform can automate aspects of data processing such that dependence on data engineers is reduced.

As part of managing the full lifecycle of feature data, the feature management platform can create the feature data. In some embodiments, the feature management platform includes an API that allows a computing device to search and discover (e.g., by providing the interface to a computing device) whether a certain feature and/or prediction exists within the feature management platform. For example, the computing device can search via a user interface the feature metadata of a feature registry in the feature management platform to determine whether a feature is stored on a data store of the feature management platform (e.g., a fast retrieval database or a training data database). In cases where the feature management platform does not already include the feature and/or prediction, the feature management platform is capable of creating the feature for and/or providing prediction to the computing device.

In some embodiments, to create a feature (e.g., a stateful feature or a stateless feature) based on both batch and streaming data, the feature management platform receives a request for the creation of the feature from a computing device associated with the feature management platform. Such request can include a processing artifact, which in some embodiments is a configuration file and/or code fragment that defines the feature.

In some cases, the configuration file can include which data source(s) to retrieve event data from, what type of transforms (or calculations) to perform on the event data, how far back and/or how long to retrieve event data, where to provide the feature vectors, etc. In such cases, the API of the feature management platform can retrieve such information from the configuration file to define the pipeline for generating the feature.

In some cases, code fragments received by the feature management platform can include functional data that can include data operations for generating feature data (e.g., aggregations, joins, and other types of data operations). For example, a computing device can provide (or transmit) the code fragment(s) along with the configuration file. In another example, the code fragment may have been provided to the feature management platform prior to the configuration file. In such cases, the processing artifact received from a computing device can include just the configuration file, and the feature management platform can use code fragments previously provided (e.g., as directed by the configuration file). The configuration file can be an object notation or data serialization configuration file format, such as a JSON file, a HOCON file, an XML, file, a YAML, file, a ZIP file, a JAR file, and so forth.

The definition of the feature can include, at least, a corresponding data source and transform to apply on the event data from the defined data source. For example, the transform can refer to the type of feature calculation for the feature management platform to perform on event data from the data source. In some cases, the processing artifact can define two different types of data sources—a batch data source and a stream data source—for generating feature data based on event data from both types of data sources.

In instances where there is both a batch data source and stream data source defined for a feature (e.g., a stateful feature or a stateless feature), the feature management platform generates two processing jobs (e.g., a batch processing job and a stream processing job) and manages the “hand-off” between processing batch data to processing streaming data. For example, after generating the two processing jobs, the feature management platform can initiate the batch processing job to retrieve event data from a batch data source, apply the transform(s) to the event data, and generate feature data until, based on the definition of the feature, there is no more event data to transform into feature data from the batch data source.

In some cases, after the batch processing job is completed, a warmer application can be implemented. The warmer application can be an application within the feature management platform that can be implemented independent of the transition between the batch processing job and the stream (or real-time) processing job. Such application can read feature vectors and retrieve a batch of feature data from the offline data store (e.g., a training data database). In some cases, the warmer application can group the feature data retrieved from the offline data store by entity associated with the feature data. Upon retrieving and grouping the feature data, the warmer application can store the feature data in the online data store (e.g., a fast retrieval database). For example, the most recent feature data generated and stored in the offline data store can be stored in the online data store. By storing the most recent feature data in the online data store in bulk, the feature management platform can reduce the number of writes of feature data to the online data store from the offline data store. In some cases, when recent feature data is stored to the online data store by the warmer application, the older feature data (e.g., feature vectors) for the corresponding entity can be discarded. Further, the warmer application can be a Spark based application but other applications capable of storing recent feature data from the offline data store to the online data store can be implemented.

Once the feature data from the batch processing job is generated, the feature data can be stored in an offline data store. The maximum timestamp associated with a feature generated can be stored in a persistent database so that when the stream processing job is initiated by the feature management platform, the stream processing job can start generating feature data where the batch processing job left off (e.g., based on the maximum timestamp). By using the maximum timestamp to determine from which event data to start processing, the feature management platform prevents the stream processing job from generating any duplication of feature data and continues processing event data without any gaps when generating feature data. Further, prior to initiating the stream processing job, the feature data generated and stored in the offline data store can also be stored to an online data store. When the stream processing job is initiated and feature data generated, the feature data can be stored in the online data store.

The stored feature data can be encapsulated as a vector, tensor, etc. For example, the vector can be stored in the feature management platform and be made available to other computing devices connected to the feature management platform for the purpose of allowing those computing devices to access and use the vector without having to duplicate the work or waste resources. In some cases, the vector can be stored in a feature store such as a fast retrieval database or a training data database, and the corresponding metadata can be stored in a feature registry.

In some cases, a computing device can use the vector for training and creating a model on the computing device. In other cases, the vector is used by a model stored locally on the computing device as part of a use case to generate a prediction. In such cases, the feature management platform can receive a transmission from the computing device of the prediction generated by the model. The prediction can be stored in the feature management platform (e.g., in the fast retrieval of training data database) and can be transmitted to other computing devices, including downstream clients. Further, the prediction(s) can be input to other models hosted local on computing devices connected to the feature management platform.

Such a feature management platform capable of managing the full life cycle of feature data minimizes dependency on data engineering, which can be resource intensive and costly. Additionally, the feature management platform reduces the time for creation, modification, deployment, and use of features because the feature management platform is a consolidated platform of components that can manage the entire lifecycle of feature data. Through automation of data processing as well as components of the feature management platform (e.g., feature registry, feature queue, etc.), the feature management platform can allow a plurality of different types of computing devices to connect to, access, and interact with the feature management platform. Further, with the connection to the feature management platform, the computing devices can discover, create, implement, share, re-use, etc., feature data without the risk of feature data duplication and expending unnecessary resources. For example, without the feature management platform, data engineers may generate non-real time feature data, including duplicate instances of feature data, that would not be reusable.

### Example Feature Management Platform

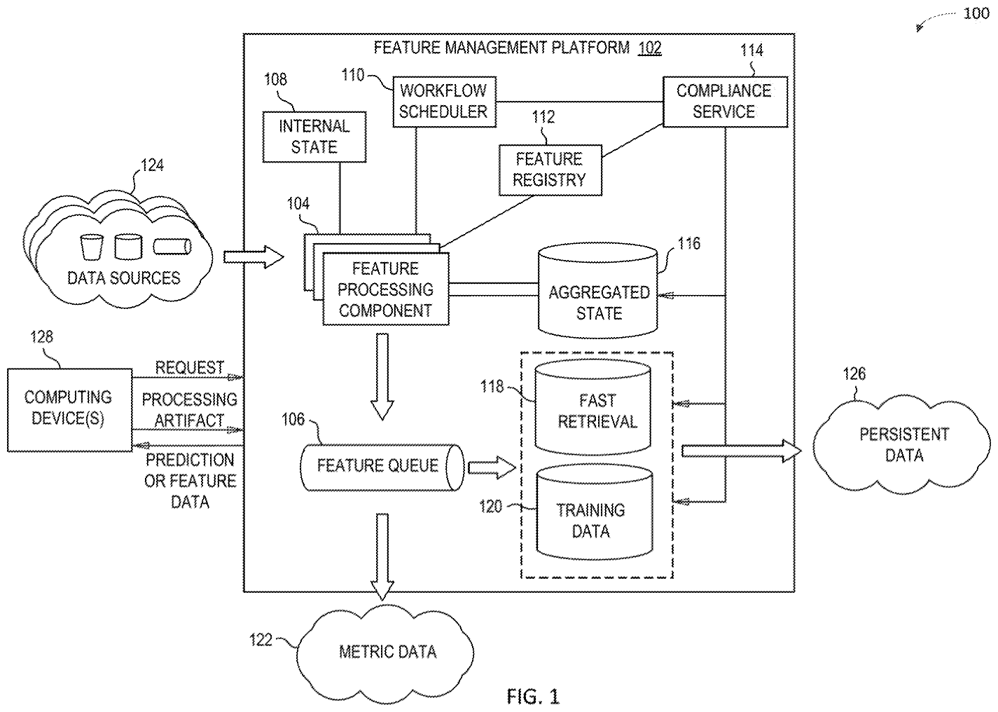

FIG. 1 depicts an example framework 100 of a feature management platform 102. The feature management platform 102 is a processing framework that supports the complete lifecycle management of feature data. For example, the feature management platform 102 supports the creation, discovery, shareability, re-usability, etc. of feature data (e.g., stateful feature data or stateless feature data) among a plurality of computing devices that connect to the feature management platform 102.

In one embodiment, the processing framework of the feature management platform 102 supports stateful feature calculations, a feature queue, and various attached storages. For stateful feature calculation, the feature management platform 102 is able to keep track of feature data, so that the feature management platform 102 can provide stateful feature data generated based on a stateful feature calculation to one or more computing devices. In some cases, the feature management platform 102 can also support a stateless feature (e.g., by determining the last value of a feature).

The feature management platform 102 includes (or is associated with) a set of components. For example, one or more components of the feature management platform 102 can be components that democratize (or e.g., make accessible) the feature management platform 102 infrastructure. Other components of the set of components of the feature management platform 102 “face” or interact directly with computing devices. Some components of the feature management platform 102 can be shared components, external services, data sources, or integration points. Due to the integration of all of the components, the feature management platform 102 is able to provide feature data (e.g., stateful or stateless features) to computing devices for AI/ML models hosted thereon and manage the full lifecycle of feature data (e.g., discovery, creation, use, deployment, etc.).

In some cases, a distributed system can implement the feature management platform 102, such that the components of the feature management platform 102 can be located at different network computing devices (e.g., servers).

In one embodiment, the feature management platform 102 can include feature processing component 104, a feature queue 106, an internal state 108, a workflow scheduler 110, a feature registry 112, a compliance service 114, an aggregated state 116, a fast retrieval database 118, a training data database 120, metric data 122, data sources 124, and persistent data 126.

The feature management platform 102 can interact with a plurality of computing devices 128. Due to the multi-tenancy of the feature management platform 102, multiple computing devices 128 can connect to, access, and use the feature management platform 102. In some cases, a computing device 128 can submit requests for feature data and/or prediction(s). In other cases, a computing device 128 can provide processing artifacts (e.g., a configuration file and/or code fragments). In other cases, the computing device 128 can retrieve feature data and/or predictions from the feature management platform 102. For example, the computing device 128 can retrieve a prediction stored by the feature management platform 102 that was generated by another computing device that locally hosts a trained model. In another example, the computing device 128 can retrieve feature data from the feature management platform 102 as a feature vector message. Computing devices 128 can include a computer, laptop, tablet, smartphone, a virtual machine, container, or other computing device with the same or similar capabilities (e.g., that includes training and implementing models, serving predictions to applications running on such computing device, and interacting with the feature management platform).

The feature processing component 104 of the feature management platform 102 can include an API for implementing transforms on event data (e.g., streaming or batch data) in order to generate feature data (or feature values) including stateful features and stateless features. Event data can include raw data from data sources associated with the feature management platform 102. For example, in the context of an organization that provides service(s) and/or product(s), the raw data can include user information (e.g., identifiers), IP addresses, counts of user action (e.g., clicks, log in attempts, etc.), timestamps, geolocation, transaction amounts, and other types of data collected by the organization.

In some cases, the feature management platform 102 can receive a processing artifact from a computing device 128. For example, the computing device 128 can be associated with an organization that is associated with (and can connect to) the feature management platform 102. Based on the processing artifact, the feature processing component 104 can generate and initiate a processing job that generates feature data.

The processing artifact can include a definition of the feature, including what data sources 124 to retrieve event data from, what transform(s) to apply to the event data, how far back and/or how long to retrieve event data, where to provide the feature vectors, etc. In such cases, the feature processing component 104 can retrieve event data from a data source 124 and apply one or more transformations to the event data to generate feature data for a period of time, based on the feature defined in the processing artifact.

The data sources 124 can include sources of batch and streaming data that connect to the feature management platform 102. In some cases, the event data from data sources 124 can be either streaming data or batch data collected by the organization(s) associated with the feature management platform 102. In order for the feature processing component 104 of the feature management platform 102 to transform event data into feature data or values (e.g., in a feature vector, tensor, etc.), event data can be retrieved from data sources 124 that are exposed (or connected via, e.g., APACHE SPARK™) to the feature management platform 102. For example, the event data can be retrieved via the API of the feature processing component 104. In some cases, the data sources 124 can include KAFKA® topics (e.g., for streaming data). In other cases, the data sources 124 can include Hive tables or S3 buckets (e.g., for batch data by the feature management platform 102).

The feature processing component 104 of the feature management platform 102 can be supported by analytics engines (e.g., APACHE SPARK™) capable of data transformation of both streaming and batch data (e.g., APACHE KAFKA® topic(s)), APACHE HIVE′ tables, AMAZON® S3 buckets). The feature processing component 104 can implement transforms by leveraging the API. In some cases, the API can be built on top of APACHE SPARK′. The API of the feature processing component 104 can support, for example, Scala, SQL, and Python as interface languages as well as other types of interface languages compatible with the API.

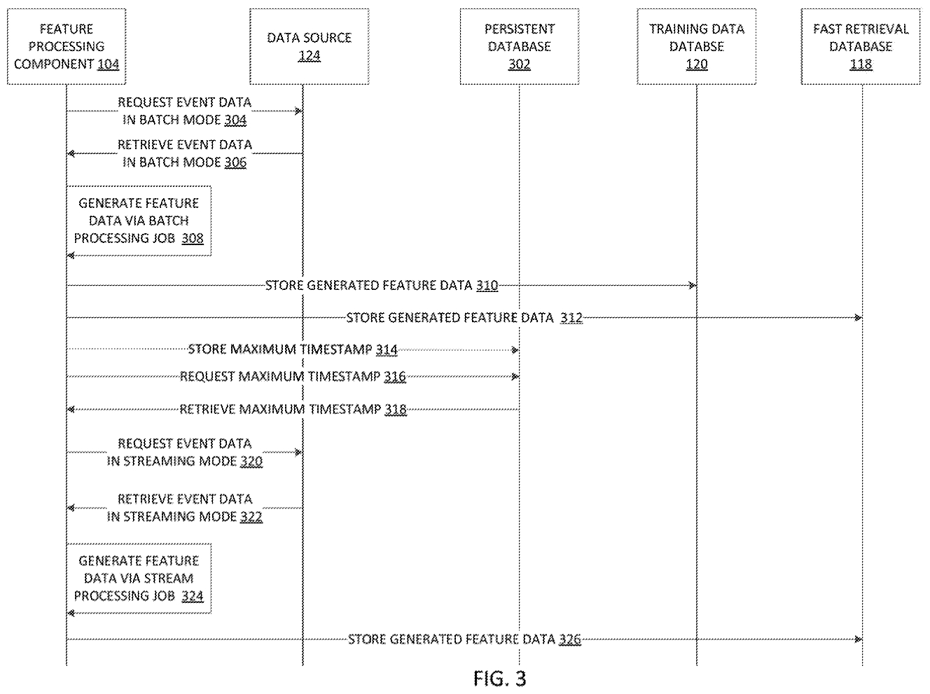

One aspect of the feature processing component 104 includes a pipeline (as described in FIG. 3) that provides the feature processing component 104 of the feature management platform 102 the ability to process event data in either streaming or batch mode to generate feature data. Further, based on the pipeline, the feature processing component 104 can backfill feature values and allow users of the feature management platform 102 to control the featurization logic and aggregation logic (e.g., by accepting processing artifacts from computing devices). In some cases, the feature processing component 104 can include a pipeline for each computing device connected to the feature management platform 102 as part of multi-tenancy support of the feature management platform 102, providing access and service to more than one computing device 128.

Upon the feature processing component 104 generating and initiating a processing job, the resulting output of the feature processing component 104 is a set of feature values (e.g., feature data). In some cases, the feature data may be encapsulated as a vector (or a set of feature vectors or tensors) and published on a feature queue 106. For example, upon determining the latest in time value of a feature (e.g., the stateless feature), the feature value can be encapsulated as a vector. In other cases, the feature data (e.g., a stateful feature) can be generated based on the feature values. For example, the feature values can be stored in an aggregated state 116 (e.g., a cache external to the feature processing component 104) and retrieved by the feature processing component 104 when an aggregation time window is complete. Upon retrieving the feature values, the feature processing component 104 can implement aggregation logic to generate the stateful feature. Once generated, the stateful feature can be encapsulated within a vector, tensor, or the like.

The feature queue 106 of the feature management platform 102 may comprise a singular write path to a multi-storage persistent layer of the feature management platform 102 (e.g., a fast retrieval database 118, a training data database 120, or other type of database). Once feature vectors are generated by the feature processing component 104, the feature vectors can be published on the feature queue 106 to provide to computing device(s) 128.

Additionally, the feature queue 106 is a queue that can protect the multi-storage persistent layer of the feature management platform 102 from “bad” code as a security measure to prevent data corruption. The feature queue 106 can act as an intermediary that provides isolation of components in the feature management platform 102 that face the computing device 128 by decoupling and abstracting featurization code (e.g., code fragment in the processing artifact) from storage. Further, the abstraction of the feature queue 106 is for both streaming and batch mode operations of the feature management platform 102.

Additionally, the feature queue 106 can include feature spaces, which can be “spaces” between published vector data. For example, the feature queue 106 can separate feature messages (e.g., vector messages) into groups or subsets prior to publishing. The feature queue 106 can separate each pipeline of feature processing from a computing device (e.g., to monitor and create alerts for feature(s)). In doing so, the feature queue 106 can allow for use case isolation and multi-tenancy support on the feature management platform 102.

For example, as more than one computing device 128 can connect to the feature management platform 102, the feature queue 106 can provide separation for the result of each processing job for each computing device 128. The feature queue 106 can provide feature parity for all data points across all storage options and a single monitoring point for data quality, drift, and anomalies as well as pipeline integrity.

The internal state 108 is a shared component of the feature management platform 102. In some cases, the internal state 108 is a service and/or database that stores information regarding the state of all applications and/or components running on the feature management platform 102. For example, data stored in the internal state 108 can include offsets, data markers, data processing and/or privacy regulations (e.g., California Consumer Privacy Act (CCPA)). The internal state 108 also includes a copy of feature metadata (or meta information) from the feature registry 112 and specific configuration items that assist in the operation of the feature management platform 102. Such storage of feature metadata and specific configuration items within the internal state 108 can be retrieved from and pushed to by the feature processing component 104 of the feature management platform 102 without any user intervention. For example, a copy of configuration information can be retrieved from the configuration file and synced to the feature registry, which can provide a user interface (e.g., via the API) to a computing device for querying information regarding features.

The workflow scheduler 110 can schedule when feature processing jobs (e.g., a processing job, a feature logic calculation, an aggregation operation, etc.) can run in the feature management platform 102. In some cases, the workflow scheduler 110 can be a tool, data manager, or service capable of executing processing jobs. For example, a workflow scheduler 110 can be based on Jenkins, APACHE AIRFLOW, ARGO EVENTS, or other similar tool, manager, or service capable of scheduling the workflow of processing jobs.

The feature registry 112 component is a central registry of the feature management platform 102. The feature processing component 104 of the feature management platform 102 can parse configuration files received from computing devices 128 and register in the feature registry 112 the features generated (as described in the configuration file) by the feature processing component 104, including stateful features and stateless features. The features registered in the feature registry 112 are discoverable (e.g., based on metadata) and can be consumed by other use cases (e.g., by other computing devices requesting the feature for locally hosted models). For example, to discover a feature, the feature registry 112 can provide a user interface via the API of the feature management platform 102.

In some embodiments, the feature registry 112 is a feature metastore that can leverage a metadata framework for storing and managing feature data. For example, the feature registry 112 can leverage APACHE ATLAS™ for feature data storage and management. The feature registry 112 can be queried to discover feature computations for reuse that have been previously implemented and registered to the feature metastore.

Further, the feature management platform 102 may be configured to comply with self-service data governance and compliance regulations (e.g., privacy laws) by registering feature data in the feature registry 112 and requiring specific key columns in feature datasets that contain user identifiable data. In some cases, a connected cascade of indexing and delete jobs in compliance with governance and compliance regulations can be triggered automatically (e.g., without user involvement) by the feature management platform 102 to manage the feature data in the feature registry 112 and attached storage layers (e.g., delete data from the fast retrieval database 118, training data database 120, and aggregated state 116).

The compliance service 114 is a component of the feature management platform 102 that is an automated workflow that ensures data is processed according to compliance regulations. For example, the compliance service 114 can monitor and ensure that data is deleted in accordance with privacy laws (e.g., CCPA). The compliance service 114 can generate an audit of data processing for the feature management platform 102. For example, the compliance service 114 can create reverse indices on a given schedule and leverage the reverse indices when performing delete requests and confirming deletion of data. In some cases, the feature management platform 102 can generate a status report of the deleted jobs.

In the instance of deleting data from a feature management platform 102, the delete job can be defined in a workflow and orchestrated by a data manager of the compliance service 114. For example, a computing device 128 can provide a request (e.g., on behalf of a user, entity, organization, etc.) to delete data in accordance with a law or regulation, such as the CCPA. Such request can be received via an API and stored in the internal state 108. Upon reaching the scheduled time for deleting data according to the request, the compliance service 114 can determine all identifiable data per the request and delete the data from data store(s). In some cases, the workflow of the delete job can be defined by services capable of organizing and cleaning data (e.g., AWS GLUE™, KUBERNETES™, etc.).

An aggregated state 116 of the feature management platform 102 can include a collection of feature data based on user-defined functions (e.g., feature calculation logic, aggregation logic, etc.). In this example, the aggregated state 116 is a distributed cache, external to feature processing component 104, which allows the feature management platform 102 to retain data state as aggregated feature data over a period of time (e.g., a number of distinct users per historic IP, a number of logins in a certain time period, etc.). In some cases, the data state can include all interim feature values that support a calculation of an aggregate function. In other cases, the aggregated state 116 can create and hold aggregated values over time per user per feature in order to provide model scorings (e.g., model scorings from AWL models).

In some cases, the aggregated state 116 can be reused for multiple features, which adds to the reusable capability of the feature management platform 102. For example, the stateful feature generated based on data from the aggregated state 116 can be requested (as well as the data in the aggregated state 116) by and provided to other computing devices 128 without having to expend additional resources. The stateful feature can be stored in the fast retrieval database 118 and/or the training data database 120, and upon receiving a request for the stateful feature, the feature management platform 102 can provide the requested stateful feature without having to re-generate the feature.

Further, the aggregated state 116 is isolated, which makes such cache independent of application errors and failures as well as infrastructure changes to the feature management platform 102. Also, the implementation of the aggregated state 116 by the feature management platform 102 can result in sub-millisecond latency of featurization transaction, which can enable close to real time prediction for AI/ML models that receive the stateful feature (as well as other feature data such as stateless feature(s)). In some cases, the aggregated state 116 can endure a throughput of 200% more (e.g., 650,000 TPS or more) for a single use case.

The fast retrieval database 118 and the training data database 120 are each a type of feature store and represents a dual storage system for the feature management platform 102. As part of the dual storage system, persistent data 126 is stored within the fast retrieval database 118 and training data database 120. The persistent data 126 may comprise feature values that are stored for model use cases or training.

For example, the fast retrieval database 118 can include recently generated feature data that can be provided to a model hosted locally on a computing device to generate real-time predictions (e.g., for model use cases and/or inferences). The fast retrieval database 118 can store the most recent (or latest) feature data at a low latency. The training data database 120 can include feature data that can be provided to train a model hosted locally on a computing device (e.g., for model training). The training data database 120 can include all of the generated feature data, including previously generated feature data.

In one example, the feature management platform 102 can generate a stateful feature regarding the number of distinct IP addresses up to a given point in time for each user name. To train a supervised machine learning model on a computing device that can generate a label for user name n at some point in time tin the past, the value of the count distinct feature for the user name n at time t can be retrieved from the feature management platform 102. In particular, the training data database 120 can include for each feature and entity, an ordered set of timestamped feature values. Such data is transmitted to the computing device 128 to train the supervised machine learning model. For a prediction or real-time inference, regarding the most recent (or up-to-date) feature value of the IP address for a user name, then such data can be retrieved from the fast retrieval database 118, which includes the latest feature values.

In some cases, the dual storage system can include a scalable database, such as a DYNAMODB™. The persistence layer of the dual storage system can serve recent feature values at low latency. In some cases, the feature values are grouped and/or compressed (e.g., by using Protobuf). Additionally, the dual storage system of the fast retrieval database 118 and the training data database 120 includes “smart updates” that prevent older feature values from being overwritten by new feature values during feature revisions (e.g., that are generated by the feature processing component 104). In some cases, the feature management platform 102 can include other types of data storage, such as a persistent database, for storing persistent data such as timestamp data.

The metric data 122 is generated by transformation of the event data that is related to the pipeline or processing job execution. The metric data 122 can be used to monitor the performance of processing jobs and to understand operation metrics. In some cases, the metric data 122 can be monitored via a monitoring platform (e.g., WAVEFRON™ by VMWare). In other cases, the metric data 122 can be used to create alerts for the feature management platform.

### Example Diagram of the Transition Between a Batch Processing Job and a Stream Processing Job

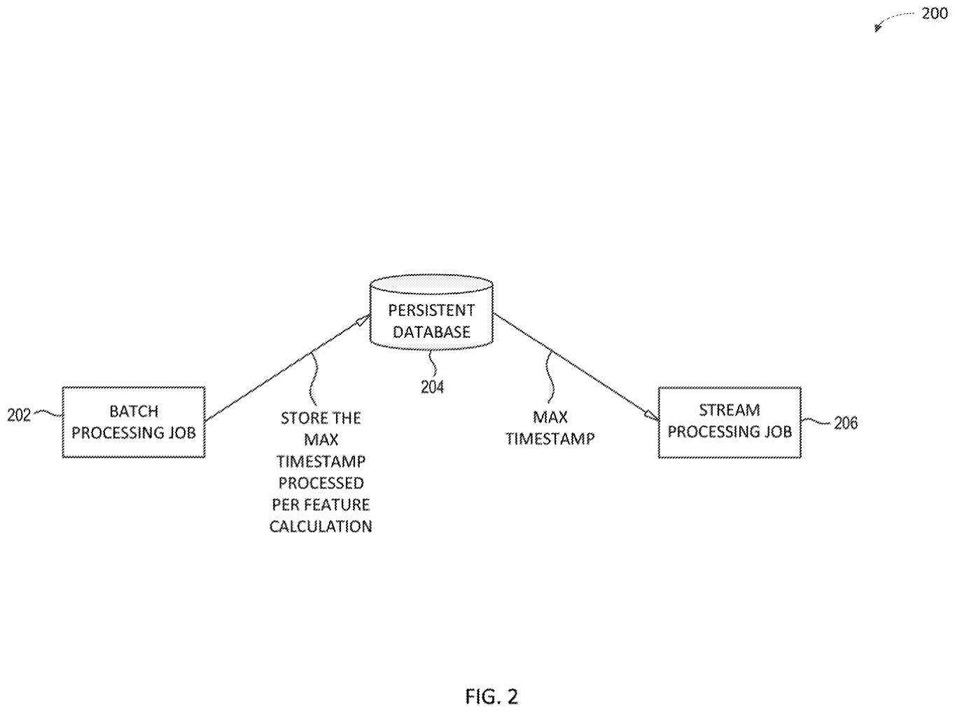

FIG. 2 depicts an example diagram 200 illustrating the transition or “hand-off” from a batch processing job to a stream processing job.

In some embodiments, when a feature management platform, such as described with respect to FIG. 1, is generating feature data, the feature data can be based on event data stored in a batch data source and a streaming data source. Batch data source can include event data previously collected and stored in data sources by an organization associated with the feature management platform. Streaming data source can include event data being collected in real-time. The event data can be stored in data sources that the feature management platform can access.

To generate feature data based on event data from both a batch data source and a streaming data source, the feature management platform can generate a processing job that includes a batch processing job 202 and a stream processing job 206. The batch processing job 202 can generate feature data based on event data previously collected. The feature data can be generated by the batch processing job 202 for a period of time in the past as indicated in the processing artifact. Upon reaching the present time (or a time parameter, e.g., in the past), the batch processing job 202 can be completed, and the maximum timestamp associated with the feature data generated by the batch processing job 202 can be stored in a persistent database 204. Both the batch processing job 202 and the stream processing job 206 can be configured to access the persistent data base 204.

The feature management platform can then transition from the batch processing job 202 to the stream processing job 206. Once the batch processing job 202 is completed, the stream processing job 206 can be initiated. The stream processing job 206 can retrieve the maximum timestamp associated with the feature data generated by the batch processing job 202. The maximum timestamp can indicate the latest (or last) feature data generated. The stream processing job 206 can retrieve event data from a streaming data source and generate feature data with timestamps that exceed the maximum timestamp retrieved. In doing so, the stream processing job 206 avoids generating feature data that was previously generated by the batch processing job 202.

In one example, the feature management platform can generate feature data for a period of time that includes event data from the past (e.g., stored in the batch data source), present (e.g., from a streaming data source), and future (e.g., to be collected by the streaming data source). The feature management platform can generate feature data based on event data not yet collected. For example, the feature data can be based on 90 days of event data, but if only 60 days of event data has been collected and stored in the batch data source, then the feature management platform can transition from retrieving event data from the batch data source to a streaming data source for 30 days to retrieve event data corresponding to the 90 days. In another example, the feature data can be updated based on event data from the streaming data source. In such an example, the feature data can be based on the most recent 90 days of event data collected. On the next day when new event data is collected, the event data from the streaming source can update the feature data so that the feature data can continue to be based on the most recent 90 days.

In some cases, the feature management platform can also generate feature data based solely on event data from the batch data source or the streaming data source.

### Example Flow Diagram of the Feature Management Platform Generating Feature Data

FIG. 3 depicts an example flow diagram 300 of the feature management platform generating feature data. In particular, the example flow diagram 300 depicts feature data generated based on event data from a batch data source and a streaming data source.

In order to generate feature data based on event data from a batch data source and a streaming data source, a feature processing component 104 can generate a processing job based on a processing artifact received by the feature management platform from a computing device. The processing artifact can include a configuration file and/or code fragment that can define the feature data to be generated including which data source(s) to retrieve event data from, what type of transforms (or calculations) to perform on the event data, how far back and/or how long to retrieve event data, where to provide the feature vectors, etc.

The feature processing component 104 can generate a processing job that includes a batch data processing job and a streaming (or real-time) data processing job. The feature processing component 104 can initiate the batch processing job first. In doing so, the feature processing component 104 can request 304 and retrieve 306 event data in batch mode from a data source 124 (e.g., batch data from a batch data source). Upon retrieving 306 the event data, the feature processing component 104 generates 308 feature data based on the batch processing job defined by the processing artifact.

In some cases, the batch data retrieved from the data source can be based on a period of time defined in the processing artifact. For example, if the processing artifact includes a start time parameter for when to retrieve event data, the feature processing component 104 can retrieve event data matching the start time parameter and continue to retrieve 306 event data from the data source 124 until the end time parameter is met. In some cases, the end time parameter is a time in the present or future. In such cases, the feature processing component 104 can retrieve event data up to the present time and then transition to initiating the stream processing job to generate feature data based on streaming data.

Once the batch processing job is completed (e.g., reaching event data time in the present), the feature data generated can be stored 310 in a training data database 120 (e.g., an offline database). The feature data can also be stored 312 in a fast retrieval database 118 (e.g., an online database). In some cases, the feature data stored in the fast retrieval database 118 is written via a warmer application. The warmer application can query the training data database 120 for the most recently generated feature data. Based on the feature data determined to be the most recently generated, the feature processing component 104 can write (e.g., via the warmer application) such feature data in bulk. In some cases, the feature processing component 104 can write the most recently generated feature data in bulk to the fast retrieval database 118 to prevent having to write multiple iterations of feature data and writing in bulk to the fast retrieval database can prevent overwriting feature data already stored in the fast retrieval database 118.

After the batch processing job generates and stores feature data, the feature processing component 104 transitions to the stream processing job. In order to initiate the stream processing job, the feature processing component 104 (as part of the batch processing job) can store 314 the maximum timestamp associated with the feature data generated by the feature processing component 104 of the feature management platform. The maximum timestamp can represent the present time and/or the end time defined by the processing artifact for retrieving event data and generating feature data based on the batch processing job. In some cases, the maximum timestamp can be stored in a persistent database 302.

To initiate the stream processing job, the feature processing component 104 can request 316 and retrieve 318 the maximum timestamp from the persistent database 302. Based on the maximum timestamp, the feature processing component 104 can determine the starting point for requesting 320 and retrieving 322 event data from a data source 124 (e.g., a streaming data source). For example, a preprocessor of the stream processing job can filter out any event data that has a timestamp less than the maximum timestamp. As such, the stream processing job can transition from the batch processing job to the stream processing job.

With the event data from the data source 124 (e.g., the streaming data source), the feature processing component 104 can generate 324 feature data based on the stream processing job. In some cases, the feature data generated by the stream processing job (e.g., as defined per the processing artifact) can be stored 326 in a fast retrieval database 118. In other cases, the feature data generated by the stream processing job can be stored in a training data database 120.

### Example Pipeline of the Feature Management Platform

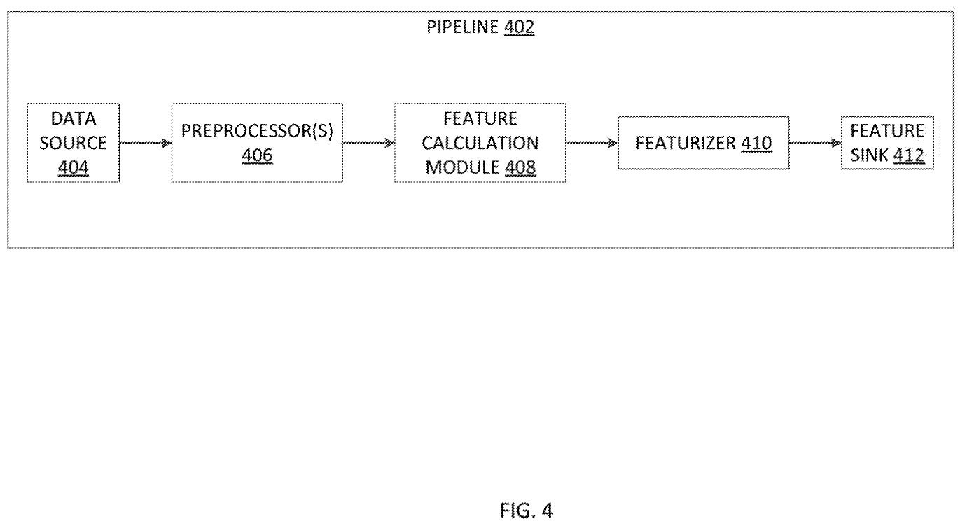

FIG. 4 depicts an example pipeline 402 of the feature management platform. In some embodiments, the example pipeline 402 is part of the feature processing component of the feature management platform. The feature management platform includes a platform API for users to interact with the feature management platform. In some cases, the API is built on top of APACHE SPARK™ and can support Scala, SQL, and Python as interface languages.

The API of the feature management platform is an entry point for a computing device (e.g., via user interface(s)) and is responsible for the generation and execution of processing jobs via a pipeline 402. In some cases, the API defining the pipeline 402 can operate in either structured streaming or in batch mode. For example, the pipeline 402 can process event data from a streaming data source or a batch data source. The same API is offered to each computing device (e.g., via user interface(s)) and can backfill features. The API defines the pipeline 402 and includes a data source 404, preprocessor(s) 406, a feature calculation module 408, a featurizer 410, and a feature sink 412. In some cases, a user interface is provided by the API for each aspect of the pipeline to define the feature (e.g., data source 404, preprocessor(s) 406, a feature calculation module 408, a featurizer 410, and a feature sink 412). The API can be agnostic and implemented on different types of databases.

For example, the feature management platform can receive a processing artifact (e.g., a configuration file and/or code fragment). Based on the processing artifact received, the API of the feature management platform can define the pipeline 402 (e.g., generates a processing job) along with input received via the user interface(s) provided by the API to the computing device(s) for generating a feature from event data.

In some cases, the data source 404 as defined (e.g., in the configuration file) for the feature can include a batch data source and/or a streaming data source from which to retrieve data from to generate feature data. In such cases, the API of the feature management platform can generate a batch processing job and a stream processing job. The batch processing job can be initiated first by the pipeline 402 to generate feature data for a defined period of time, up to the present time. Upon reaching the present time, the batch processing job can be completed, and the stream processing job can be initiated. For example, the pipeline 402 can retrieve event data from a batch data source for the batch processing job and can retrieve event data from the streaming data source for the stream processing job once the batch processing job is completed.

The data source 404 can include HIVE, EBUS™, S3™, or other data sources capable of storing data. The preprocessor(s) 406 can be chained together or sequentially executed to filter out event data. For example, if click stream data was retrieved from the data source 404, then the preprocessor(s) 406 can filter out (or remove) test data prior to calculation by the feature calculation module 408.

The feature calculation module 408 can perform operations (e.g., as defined by a user interface and/or configuration file). For example, the feature calculation module 408 can perform feature logic calculations and aggregation operations (e.g., a count, average, and other types of operation on event data and/or feature data). The feature calculation module 408 can implement the aggregation operation(s) as defined by the processing artifact to generate a stateful feature.

In some cases, the feature calculation module 408 can perform the calculation of event data in parallel in the pipeline 402. The feature calculation module 408 can generate a table of results, and the featurizer 410 can transform the table into a feature vector format or tensor. The featurizer 410, upon generating the feature vector by transforming the table results of the feature calculation module 408, can then push the feature vector to the feature sink 412. In some cases, the feature sink 412 can be a feature queue of the feature management platform (e.g., a feature queue 106 as described in FIG. 1) that publishes the feature vector for a computing device.

### Example Configuration File

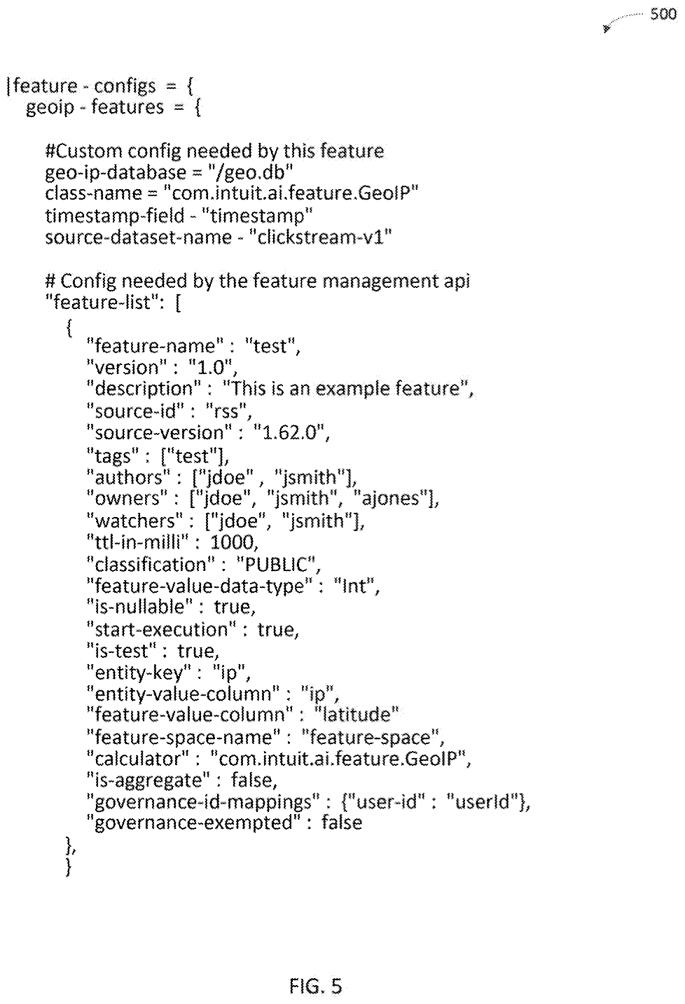

FIG. 5 depicts an example configuration file 500. In one example, configuration file 500 may be provided by a user via a computing device to the feature management platform. In such cases, the computing device can provide the configuration file as part of a processing artifact (e.g., with a code fragment) when requesting a feature in cases where the feature management platform does not include the feature in the feature registry. For example, the computing device can generate the configuration file and transmit the configuration file as part of the processing artifact to the feature management platform.

The configuration file 500, along with code fragments, defines the feature requested as well as identifies the data source to retrieve event data and the type of transform to be applied to the event data. In some cases, the configuration file received from a computing device can be an object notation or data serialization configuration file format, such as a JSON file, a HOCON file, an XML, file, a YAML, file, a ZIP file, a JAR file, and so forth.

In the depicted embodiment, the following data types are defined in configuration file 400: a “feature-name”, “version” of the feature, “description” of the feature, source identification (“source-id”), “source-version”, “tags”, “authors”, “owners”, “watchers”, “ttl-in-milli”, “classification”, “feature-value-data-type”, “is-nullable”, “start-execution”, “is-test”, “entity-key”, “entity-value-column”, “feature-value-column”, “feature-space-name”, “calculator”, “is-aggregate”, “governance-id-mapping”, and “governance-exempted”. In some cases, the definitions of the feature can include more than one value, such as “authors”, “owners”, and “watchers”. For example, as depicted in the example configuration file 500, “authors” includes “jdoe” and “jsmith”.

In some cases, the configuration file 500 of the processing artifact can define additional parameters specific to stateful featurization. For example, the configuration file can include a time parameter for the period of time associated with the stateful feature (e.g., a start time and end time for retrieving event data and generating feature data). In other cases, the configuration file 500 of the processing artifact can include stateful feature data for generation other types of feature data (e.g., hierarchical features). For example, when the transformation by the feature management platform begins to consume feature outputs, as a result, other feature spaces (e.g., such as hierarchical features) can be defined as an input in the configuration file 500.

### Example Flow Diagram of the Feature Management Platform Managing Feature Data

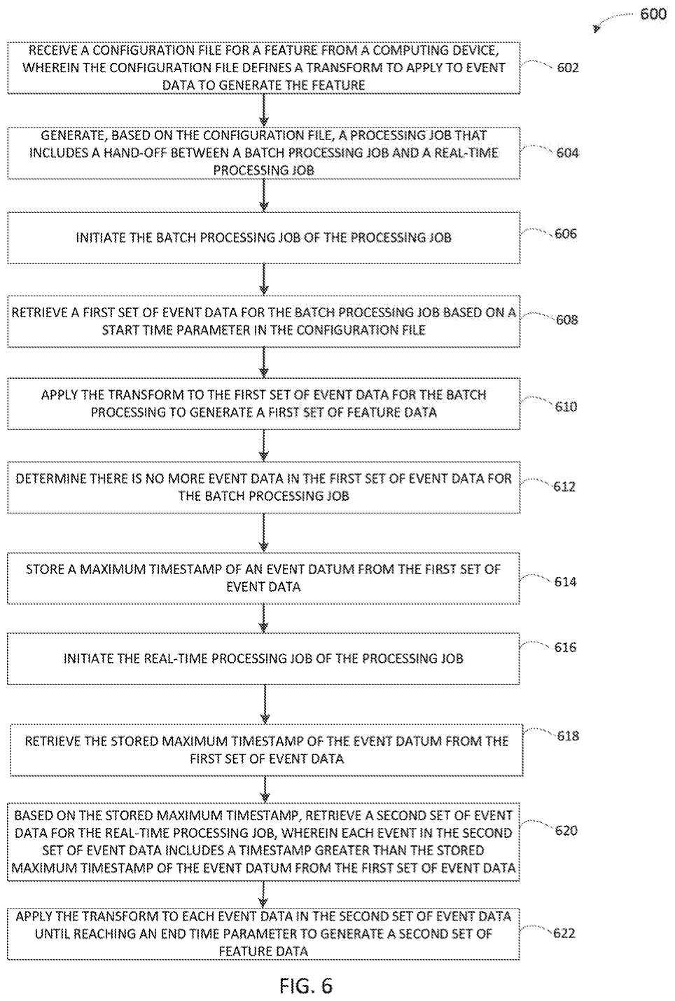

FIG. 6 depicts an example method 600 of managing feature data, such as by the feature management platform 102 of FIG. 1. In particular, the example flow diagram 600 depicts the transition between a batch processing job and a stream processing job to generate feature data (e.g., a stateful feature or a stateless feature) based on a batch data source and a streaming data source.

At step 602, the feature management platform receives a configuration file for a feature from a computing device, wherein the configuration file defines a transform to apply to event data to generate the feature. In some cases, the configuration file can be for a stateless feature, defining the last or most recent value of a feature. In other cases, the configuration file can be for a stateful feature, defining an aggregation of features over a period of time.

The event data can be retrieved from a batch data source and a streaming data source to generate the feature data (e.g., the stateful feature or the stateless feature). The feature management platform can receive the configuration file as part of a processing artifact that can also include code fragment. In some cases, the processing artifact can include a configuration file and/or code fragments in a type of file capable of the definition of the feature.

The feature management platform can also receive via the processing artifact and/or user interfaces provided by the API input data for feature logic calculations and aggregation operations for generating the feature. For example, the input data can also include an aggregation time window for implementing the feature logic calculations in order to generate the stateful feature.

At step 604, the feature management platform generates, based on the configuration file (and any code fragment provided), a processing job. The processing job can include a batch processing job, a stream processing job, and a hand-off between the batch processing job and the stream processing job. The processing job can be defined by an API of the feature management platform.

The API of the feature management platform can define a pipeline for processing event data from the batch data source and the streaming data source. In some cases, the processing job generated by the feature management platform includes a pipeline identification that is shared with the batch processing job and the stream processing job. The batch processing job and the stream processing job can both be implemented on the pipeline defined by the API of the feature management platform (e.g., as described in FIG. 4).

At step 606, the feature management platform initiates the batch processing job of the processing job. In some cases, the batch processing job initiated by the feature management platform can backfill feature values (or feature data) of a stateful feature, based on a period of time defined in the processing artifact for the stateful feature.

At step 608, the feature management platform retrieves a first set of event data for the batch processing job based on a start time parameter in the configuration file.

At step 610, the feature management platform applies the transform to the first set of event data for the batch processing job to generate a first set of feature data.

At step 612, the feature management platform determines there is no more event data in the first set of event data for the batch processing job.

At step 614, the feature management platform stores a maximum timestamp of an event datum from the first set of event data.

At step 616, the feature management platform initiates the stream processing job of the processing job. In some cases, the stream processing job can provide updates to the stateful feature. For example, if the batch processing job can backfill the feature data to generate a stateful feature up to the present time, the stream processing job can update the stateful feature based on streaming event data.

At step 618, the feature management platform retrieves the stored maximum timestamp of the event datum from the first set of event data.

At step 620, the feature management platform, based on the stored maximum timestamp, retrieves a second set of event data for the stream processing job, wherein each event in the second set of event data includes a timestamp greater than the stored maximum timestamp of the event datum from the first set of event data.

At step 622, the feature management platform applies the transform to each event data in the second set of event data until reaching an end time parameter to generate a second set of feature data. The end time parameter can be based on the configuration file or input data received by the feature management platform via a user interface provided by the API of the feature management platform.

In some cases, the feature data generated by the batch processing job and the stream processing job can be published to the feature queue of the feature management platform.

In some cases, the feature management platform can generate stateful feature based on the feature data generated by the batch processing job and the stream processing job. In such case, the feature data can be stored in a cache of the feature management platform (e.g., external to the feature processing component of the feature management platform) until sufficient feature data has been generated to implement aggregation operations, as per the processing artifact, to generate the stateful feature. Once the stateful feature is generated, the stateful feature can be provided to the feature queue.

In other cases, the feature management platform can generate a stateless feature based on the most recent (in time) value of a feature. For example, a stateless feature can include the latest login attempt of a user to account, the latest IP address associated with a user, most recent zip code associated with a user, and so forth.

### Example Computing Device Interacting with the Feature Management Platform

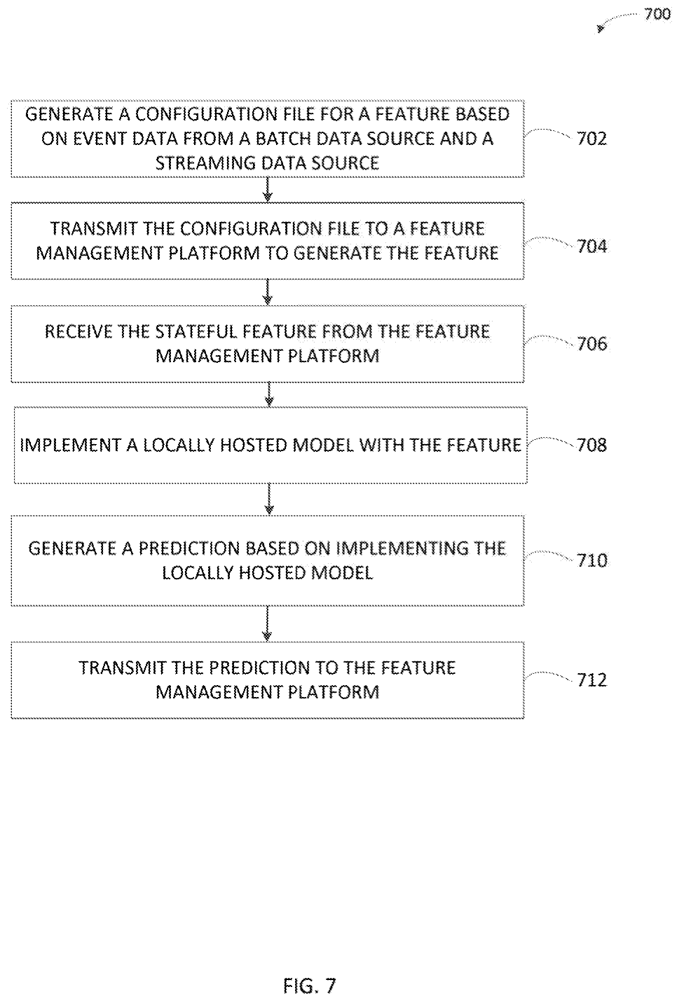

FIG. 7 depicts an example method 700 of a computing device interacting with a feature management platform, as described with respect to FIG. 1.

At step 702, the computing device generates a configuration file for a feature based on event data from a batch data source and a streaming data source. The configuration file can define a feature (e.g., a stateful or stateless feature) for the feature management platform, including a data source (e.g., the batch data source and streaming data source) to retrieve event data from, the type of transform (or calculation) to perform on the event data, how far back and/or how long to retrieve event data, etc.

For example, the configuration file can be an object notation or data serialization configuration file format, such as a JSON file, a HOCON file, an XML file, a YAML file, a ZIP file, a JAR file, and so forth. In some cases, the computing device can generate code fragments to include with the configuration file. The code fragments can include context data of the stateful feature to be generated. In some cases, the feature management platform may have received the code fragment previously from another computing device.

At step 704, the computing device transmits the configuration file to a feature management platform to generate the feature. In the instance that code fragments are generated, the computing device can transmit the code fragments with the configuration file as part of a processing artifact.

At step 706, the computing device receives the feature from the feature management platform. In some cases, the computing device that transmitted the configuration file (and the code fragments) can receive the feature. In such cases, the feature received from the feature management platform can be a single vector message that includes a feature vector representing the feature.

At step 708, the computing device implements a locally hosted model with the stateful feature. In some cases, a computing device can use the stateful feature received from the feature management platform to generate a prediction. In other cases, the computing device can use the feature to train a locally hosted model.

At step 710, the computing device generates a prediction with the vector based on implementing the locally hosted model.

At step 712, the computing device transmits the prediction generated to the feature management platform.

In some cases, a different computing device and/or model can request from the feature management platform the same prediction transmitted at step 712. In such cases, the feature management platform can transmit the prediction to the different computing device, without having to expend additional resources to generate the prediction. For example, the different computing device can search the feature registry (e.g., via a user interface provided by the API of the feature management platform) to determine whether the prediction is stored in the feature management platform.

### Example Server for the Feature Management Platform

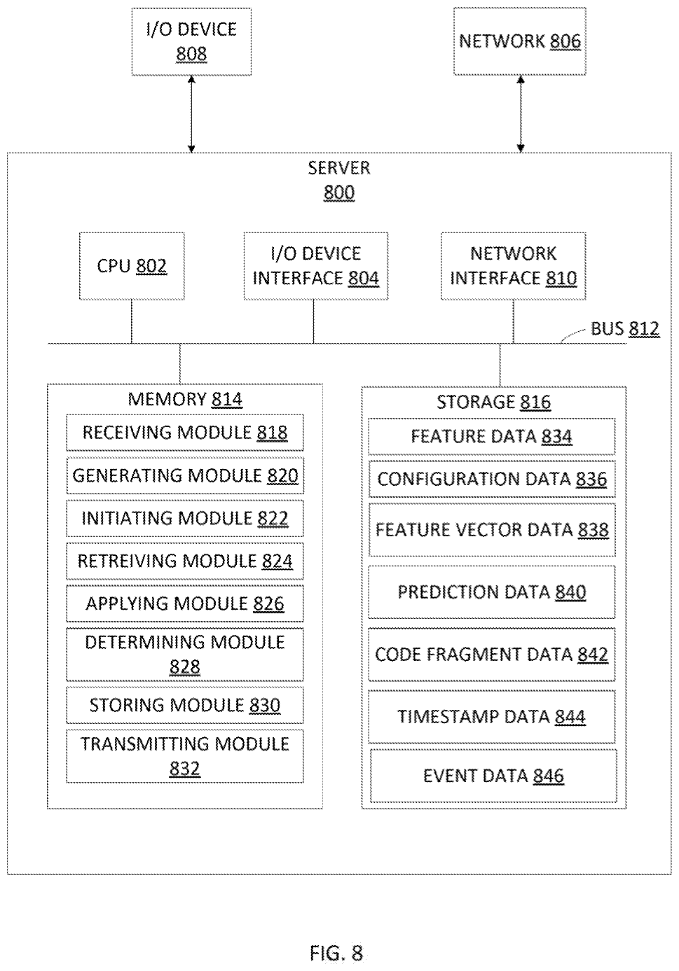

FIG. 8 depicts an example server 800 that may perform the methods described herein, for example, with respect to FIGS. 1-6. For example, the server 800 can be a physical server or a virtual (e.g., cloud) server and is not limited to a single server that performs the methods described herein, for example, with respect to FIGS. 1-6.

Server 800 includes a central processing unit (CPU) 802 connected to a data bus 812. CPU 802 is configured to process computer-executable instructions, e.g., stored in memory 814 or storage 816, and to cause the server 800 to perform methods described herein, for example with respect to FIGS. 1-6. CPU 802 is included to be representative of a single CPU, multiple CPUs, a single CPU having multiple processing cores, and other forms of processing architecture capable of executing computer-executable instructions.

Server 800 further includes input/output (I/O) device(s) 808 and interfaces 804, which allows server 800 to interface with input/output devices 808, such as, for example, keyboards, displays, mouse devices, pen input, and other devices that allow for interaction with server 800. Note that server 800 may connect with external I/O devices through physical and wireless connections (e.g., an external display device).

Server 800 further includes network interface 810, which provides server 800 with access to external network 806 and thereby external computing devices.

Server 800 further includes memory 814, which in this example includes a receiving module 818, a generating module 820, an initiating module 822, a retrieving module 824, an applying module 826, a determining module 828, a storing module 830, and a transmitting module 832, for performing operations described in FIGS. 1-6.

Note that while shown as a single memory 814 in FIG. 8 for simplicity, the various aspects stored in memory 814 may be stored in different physical memories, but all accessible by CPU 802 via internal data connections such as bus 812.

Storage 816 further includes feature data 834, which may be like the feature data generated based on implementing feature logic calculations, aggregation operations, etc., such as stateful features and stateless features, and feature metadata as described in FIGS. 1-6.

Storage 816 further includes configuration data 836, which may include the configuration file, as described in FIGS. 1-6.

Storage 816 further includes feature vector data 838, which may include vectors representing feature data (or values), as described in FIGS. 1-6.

Storage 816 further includes prediction data 840, which may include prediction(s) received from a computing device that locally implemented a model with feature data (e.g., vectors) received from the feature management platform, as described in FIGS. 1-6.

Storage 816 further includes code fragment data 842, which may include code fragment data that is received by the feature management platform (e.g., with the configuration file), as described in FIGS. 1-6.

Storage 816 further includes timestamp data 844, which includes timestamp data corresponding to the feature data generated, as described in FIGS. 1-6.

Storage 816 further includes event data 846, which includes event data (or raw events) retrieved from one or more data source associated with the feature management platform, as described in FIGS. 1-6.

While not depicted in FIG. 8, other aspects may be included in storage 816.

As with memory 814, a single storage 816 is depicted in FIG. 8 for simplicity, but various aspects stored in storage 816 may be stored in different physical storages, but all accessible to CPU 802 via internal data connections, such as bus 812, or external connection, such as network interfaces 804. One of skill in the art will appreciate that one or more elements of server 800 may be located remotely and accessed via a network 806.

### Example Computing Device

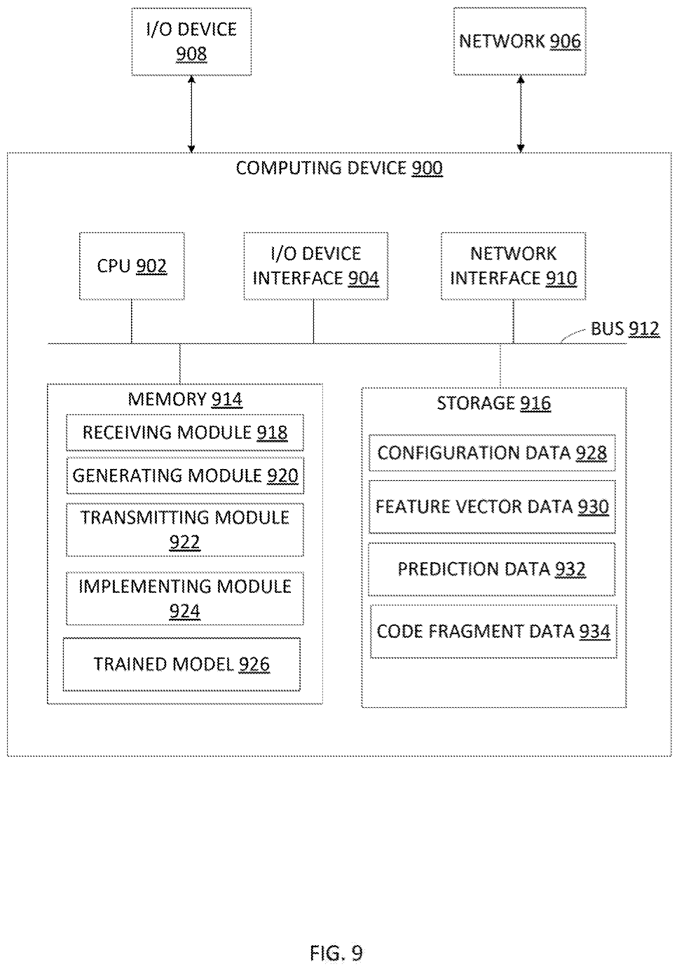

FIG. 9 depicts an example computing device 900 that may perform the methods described herein, for example, with respect to FIGS. 1, 7. For example, the computing device 900 can be a computer, laptop, tablet, smartphone, a virtual machine, container, or other computing device with the same or similar capabilities (e.g., that includes training and implementing models, serving predictions to applications running on such computing device, and interacting with the feature management platform). The methods described herein, for example, with respect to FIGS. 1, 7 can be performed by one or more computing devices 900 connected to the feature management platform.

Computing device 900 includes a central processing unit (CPU) 902 connected to a data bus 912. CPU 902 is configured to process computer-executable instructions, e.g., stored in memory 914 or storage 916, and to cause the computing device 900 to perform methods described herein, for example with respect to FIGS. 1, 7. CPU 902 is included to be representative of a single CPU, multiple CPUs, a single CPU having multiple processing cores, and other forms of processing architecture capable of executing computer-executable instructions.

Computing device 900 further includes input/output (I/O) device(s) 908 and interfaces 904, which allows computing device 900 to interface with input/output devices 908, such as, for example, keyboards, displays, mouse devices, pen input, and other devices that allow for interaction with computing device 900. Note that computing device 900 may connect with external I/O devices through physical and wireless connections (e.g., an external display device).

Computing device 900 further includes network interface 910, which provides computing device 900 with access to external network 906 and thereby external computing devices.

Computing device 900 further includes memory 914, which in this example includes a receiving module 918, a generating module 920, a transmitting module 922, an implementing module 924, and a trained model 926 for performing operations described in FIGS. 1, 7.

Note that while shown as a single memory 914 in FIG. 9 for simplicity, the various aspects stored in memory 914 may be stored in different physical memories, but all accessible by CPU 902 via internal data connections such as bus 912.

Storage 916 further includes configuration data 928, which may be like the configuration file, as described in FIGS. 1, 5, 7.

Storage 916 further includes feature vector data 930, which may include the vector representing the stateful feature and stateless feature, as described in FIGS. 1, 7.

Storage 916 further includes prediction data 932, which may include prediction(s) generated by a computing device that locally implemented a model with feature data (e.g., vectors, tensors, etc.) received from the feature management platform, as described in FIGS. 1, 7.

Storage 916 further includes code fragment data 934, which may include code fragment data that is generated by the computing device and provided to the feature management platform, as described in FIGS. 1, 7.

While not depicted in FIG. 9, other aspects may be included in storage 916.

As with memory 914, a single storage 916 is depicted in FIG. 9 for simplicity, but various aspects stored in storage 916 may be stored in different physical storages, but all accessible to CPU 902 via internal data connections, such as bus 912, or external connection, such as network interfaces 904. One of skill in the art will appreciate that one or more elements of computing device 900 may be located remotely and accessed via a network 906.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other circuit elements that are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving a configuration file for a feature from a computing device, wherein the configuration file defines a transform to apply to event data to generate the feature;
generating, based on the configuration file, a processing job that includes a hand-off between a batch processing job and a stream processing job;
initiating the batch processing job of the processing job that includes:
retrieving a first set of event data for the batch processing job based on a start time parameter in the configuration file;
applying the transform to the first set of event data for the batch processing job to generate a first set of feature data;
determining there is no more event data in the first set of event data for the batch processing job; and
storing a maximum timestamp of an event datum from the first set of event data; and
initiating the stream processing job of the processing job that includes:
retrieving the stored maximum timestamp of the event datum from the first set of event data;
based on the stored maximum timestamp, retrieving a second set of event data for the stream processing job, wherein each event in the second set of event data includes a timestamp greater than the maximum timestamp of the event data from the first set of event data; and
applying the transform to each event data in the second set of event data until reaching an end time parameter to generate a second set of feature data.

2. The method of claim 1, further comprising: publishing each feature data from the first set of feature data and the second set of feature data in a feature queue to provide to the feature to the computing device.

3. The method of claim 1, further comprising: prior to initiating the stream processing job, storing the first set of feature data from an offline database to an online database.

4. The method of claim 3, further comprising: querying the offline database for the first set of feature data.

5. The method of claim 1, further comprising: backfilling the feature by initiating the batch processing job based on a period of time associated with the feature.

6. The method of claim 1, further comprising: updating the feature based on the stream processing job.

7. The method of claim 1, further comprising: storing the maximum timestamp of the event datum from the first set of event data in a persistent database that the batch processing job and the stream processing job are configured to access.

8. The method of claim 1, wherein the processing job is associated with a pipeline identification shared with the batch processing job and the stream processing job.

9. The method of claim 1, wherein the batch processing job and the stream processing job is initiated in a single pipeline.

10. A system, comprising:
a processor; and
a memory storing instructions, which when executed by the processor perform a method comprising:
receiving a configuration file for a feature from a computing device, wherein the configuration file defines a transform to apply to event data to generate the feature;
generating, based on the configuration file, a processing job that includes a hand-off between a batch processing job and a stream processing job;
initiating the batch processing job of the processing job that includes:
retrieving a first set of event data for the batch processing job based on a start time parameter in the configuration file;
applying the transform to the first set of event data for the batch processing job to generate a first set of feature data;
determining there is no more event data in the first set of event data for the batch processing job; and
storing a maximum timestamp of an event datum from the first set of event data; and
initiating the stream processing job of the processing job that includes:
retrieving the stored maximum timestamp of the event datum from the first set of event data;
based on the stored maximum timestamp, retrieving a second set of event data for the stream processing job, wherein each event in the second set of event data includes a timestamp greater than the stored maximum timestamp of the event datum from the first set of event data; and
applying the transform to each event data in the second set of event data until reaching an end time parameter to generate a second set of feature data.

11. The system of claim 10, wherein the method further comprises: publishing each feature data from the first set of feature data and the second set of feature data in a feature queue to provide to the feature to the computing device.

12. The system of claim 10, wherein the method further comprises: prior to initiating the stream processing job, storing the first set of feature data from an offline database to an online database.

13. The system of claim 12, wherein the method further comprises: querying the offline database for the first set of feature data.

14. The system of claim 10, wherein the method further comprises: backfilling the feature by initiating the batch processing job based on a period of time associated with the feature.

15. The system of claim 10, wherein the method further comprises: updating the feature based on the stream processing job.

16. The system of claim 10, wherein the method further comprises: storing the maximum timestamp of the event datum from the first set of event data in a persistent database that the batch processing job and the stream processing job are configured to access.

17. The system of claim 10, wherein the processing job is associated with a pipeline identification shared with the batch processing job and the stream processing job.

18. The system of claim 10, wherein the batch processing job and the stream processing job is initiated in a single pipeline.

19. A method, comprising:
generating a configuration file for a feature;
transmitting the configuration file to a feature management platform to generate the feature;
receiving the feature from the feature management platform;
implementing a locally hosted model with the feature;
generating a prediction based on implementing the locally hosted model; and
transmitting the prediction to the feature management platform.

20. The method of claim 19, wherein the feature received from the feature management platform is a vector for input to the locally hosted model.
